(19) United States
(12) Patent Application Publication
(10) Pub. No.: US 2018/0351181 A1
(43) Pub. Date: Dec. 6, 2018

(54) Energy Storage and Conversion Systems

(71) Applicants: John Read, San Diego, CA (US); Daniel Sweeney, San Diego, CA (US)

(72) Inventors: John Read, San Diego, CA (US); Daniel Sweeney, San Diego, CA (US)

(21) Appl. No.: 15/607,746

(22) Filed: May 30, 2017

(51) Int. Cl. H01M 6/36; H02J 15/00; F24J 2/00

(52) U.S. Cl. CPC H01M 6/36; F24J 2/0015; H02J 15/00

(57) ABSTRACT

Energy storage and conversion systems are, formed when tightly integrated components including thermochemical storage subsystem with a concentration cell to provide very high capacity and high energy density systems. Systems taught here include the unique combination of a thermochemical energy storage module in close thermal communication with a direct energy converter in the form of a concentration cell. A closed-loop thermochemical module receives heat input at a receiving port to drive a reversible chemical reaction. The end-to-end system achieves an ‘on-demand’ functionality because the reagents of said chemical reaction may be safely stored for long periods of time without detrimental effect. When these reagents are again reunited, they produce heat that may be transmitted to the direct energy converter arranged to convert so received heat directly into an electric output suitable for doing work on an external system. Heat from the storage system drives a working fluid of the concentration cell type direct converter to ionize it. Electrons separated from atoms or molecules of the gas at a very special membrane arranged to efficiently facilitate ion migration form an electrical current that is operable for doing work when applied to an external load. Upon recombination with the ions the working fluid is restored to its original state and becomes available for another cycle. Thus, the direct energy converter or concentration cell is also a closed-loop system.

### BACKGROUND OF THE INVENTION

This patent application stands on its own as an original new and initial application for patent without continuation dependence from any other earlier filed applications.

### Field

The following invention disclosure is generally concerned with energy storage, retrieval, and conversion and specifically concerned with such energy systems having a combination of a thermochemical energy storage module coupled with a concentration cell to provide direct to electric energy conversion. On-demand, high capacity, energy storage and conversion systems smaller than industrial scale is presently a field not well populated with system choices. The present inventions and systems fit into this unique class of energy systems.

### Related Systems

Thermal energy storage has not been usefully employed across any appreciable range of applications, though it has been used for over a considerable period of time. For example, thermal storage by means of the conservation of sensible heat within building materials of high thermal mass represents an application present in many traditional forms of architecture, and stands as one of the few well established uses. Such systems are easy to deploy, trivial to maintain, and not very expensive. In such implementations the conserved thermal energy is absorbed, generally in the form of solar radiation, during the hours of sunlight, and then gradually released at night in order to provide a degree of thermal equilibrium in a building. Such practices go back to remote antiquity to the first use of masonry in human dwellings.

In some other well used thermal energy storage systems, a kind of cooling is achieved. Indeed, some modern air-conditioning used in large building includes a system whereby ice is made during the nighttime hours when electricity prices are less. During the daytime when air conditioning is demanded, the ice goes through a phase change and converts from its solid form back into liquid while passing heat energy (cooling) to an transport medium (air) and this conveys the thermal energy to living and/or office spaces where humans can remain in comfort.

Thermal energy storage manner, technique and systems of this invention stand apart from the other energy storage technologies more commonly known and deployed in all areas of energy management today. Presently, thermal storage systems on an industrial scale have seen limited use and are deployed only practically by those few public utilities generating electricity by means of solar thermal installations: it seems not to have application far beyond that special case inasmuch as energy conversion processes from heat to electricity have historically been markedly inefficient, and the devices for performing that process, markedly expensive. For these reasons among others, thermal energy storage remains a field ripe for improvements.

Thermochemical storage has been combined various types of heat engines, mostly in the context of solar thermal installations where such storage provides a thermal power source when sunlight is unavailable. Latent heat thermal storage has also been combined with at least one type of direct thermal to electric conversion. Latent heat and sensible heat thermal storage have also been combined with external combustion heat engines such as steam turbines and Stirling cycle engines. Thermochemical storage of energy in systems not characterized as those described remains of interest but not well attended by industry and investment.

Previous researchers have provided unique thermochemical arrangements that have achieved energy densities considerably greater than those of batteries, and such combined storage and energy conversion systems have even been installed in vehicles including so-called fireless locomotives and submarines, both of which appeared as commercial products in the past.

Currently thermal storage is an under used technology, however, and has yet to achieve either its performance or market potential. In part, because it remains far cheaper to burn hydrocarbons to provide driving heat for many types of energy systems, little motivation and commensurate investment has left exploration of this field sparse.

### The Context of Mass Energy Storage

Mass energy storage technologies, for the most part, fall into two groupings, those basically mechanical in nature, and those that store electrical charge within chemical bonds. Thermal storage forms a third subcategory, though one without much representation in the marketplace at present.

The mechanical storage methods include pumped hydroelectric systems and compressed air storage. Both tend to be the exclusive province of large public utilities, particularly those with a major role in managing the electrical transmission grid.

Electrochemical systems include batteries and regenerative fuel cells. The latter subset has so little presence in the marketplace and so little likelihood of increasing that presence that it can safely be ignored at this time.

Batteries enjoy ubiquitous presence in personal and portable electrical and electronic devices, both in industrial and in consumer settings. Batteries have also begun to play a major role in mass storage within public utilities, and are used in such applications as load leveling, peak power shaving, frequency stabilization and voltage stabilization. They are also finding a place within industrial settings. Backup power capable of sustaining operations over the span of many hours in the face of grid instabilities has become a crucial requirement in many manufacturing and service organizations. Purveyors of battery-based mass storage systems also eye domestic markets and independent micro grid operators serving individual communities.

### Battery Strengths

A number of well-established and quite distinct battery chemistries compete with one another in the marketplace, each offering its own unique combination of performance attributes, such that characterizing the technology overall presents difficulties. In the main, batteries offer rapid response times, high to very high round trip efficiencies (though there are exceptions), some ability to follow fluctuating electrical loads, and high energy density compared to many competing technologies. Most chemistries also provide for a high degree of modularity such that systems can scale to almost any size by aggregating modular elements.

Strengths of current battery technologies have led to a very rapid adoption cycle among public utilities, and among the new class of specialized storage service providers who market such services to utilities. Similarly rapid adoption has characterized the behavior of industrial and institutional mass storage users.

At meso and micro scales batteries have represented the energy technology of choice for over a century and a quarter. At macro scale batteries have only firmly established themselves over the course of the last two decades The ascendancy of batteries in utility scale storage derives less from performance breakthroughs than from growing realization on the part of utilities that reliable and cost effective mass storage could allow the utility to track demand and avoid outages and disruptions without increasing generation capacity. Utilities also understand that mass storage could open up opportunities in trading and arbitrage scarcely possible if a virtual bank of energy is not ready at hand to be sold or withheld from the market.

### Battery Limitations

Whatever their position in the energy landscape as capital investments, which grows stronger by the week, batteries suffer from certain seemingly inherent limitations which present formidable obstacles, difficult to ameliorate.

Batteries are almost all essentially short lived devices with limited cycle lives exception redox flow batteries. Most types of batteries cannot be reconditioned, and thus must be scrapped at the conclusion of their operating lives. While most types, of batteries can be recycled, recovery of electrochemically active and structural materials is usually incomplete.

Battery chemistries are extremely temperature sensitive, and operate best at room temperature. Temperatures in excess of 100 C can destroy or degrade many types of batteries, while temperatures approaching 0 C or below will greatly reduce energy recovery.

Batteries without exception have poor power density, that is, they cannot greatly exceed their steady state power outputs and cannot be rapidly discharged without undergoing severe damage, in some instances to the point of outright failure. Conversely, batteries are limited in their ability to absorb charge quickly.

All batteries lose charge over time, often over the space of hours. Thus batteries alone cannot provide for highly reliable backup power unless they are continually trickle charged.

Batteries are easily damaged by overcharging and by the appearance of over-voltages on their terminals. Input voltage must be strictly regulated.

Most battery chemistries do not permit anything approaching full discharge with any degree of safety. Few batteries can endure the loss of even 50% of charge without incurring permanent damage.

Many batteries exhibit what is known as “memory”, that is, a tendency to change certain operating parameters based upon charge and discharge history.

Finally, many types of batteries contain toxins or inflammable materials and thus pose significant safety hazards. Some chemistries are also unstable and susceptible to parasitic reactions that result in the failure of the unit and even the rupture of the casing.

Batteries must be regarded as a mature technology which is far along its development curve and unlikely to manifest step improvements in the future. Huge expenditures on basic research in the course of the last few decades have not resulted in performance breakthroughs. Therefore incremental performance enhancements are probably the best that can be expected.

### The Universe of Thermal to Electrical Energy Conversion

Many means exist for transforming thermal energy into an electrical output, but all such technologies fall within only two main categories, heat engines and direct thermal to electric convertors. It is only with the latter that this invention is concerned.

Heat engines may make use of mechanical or acoustical transducers to generate electricity from the expansive force of a heated gas, or, in some instances, a supercritical fluid or even a solid, but there is always an intervening energy conversion within the overall energy conversion process. Some such devices have achieved impressively high conversion efficiencies, but not within compact form factors and not with much cost effectiveness. Direct conversion devices become rather attractive in this context.

### DETAILED DESCRIPTION

Systems coming within the scope of this invention can assume, a considerable number of forms, and can utilize various heat sources, electrical to thermal convertors, thermochemical cycles, reaction chamber designs, heat exchangers and thermal transfer systems, and different subcategories of concentration cell convertors.

### Thermal Input System

The thermal input system is not precisely the same as the heat source, though it may include a heat source. It is instead a means of conveying thermal energy into the second stage, the heat storage unit. It may draw thermal energy from the environment, or it may possess some means of transforming another form of energy into thermal energy.

Systems that Draw Heat from the Environment

These extract thermal energy from an environmental source such as sunlight, the earth itself, or the ambient air. They include solar receivers, geothermal energy collectors, and heat pumps.

Solar receivers: these receive the radiant, input from an optical solar concentrator and use that input to warm a conductive or convective thermal medium or to drive a thermochemical reaction directly. A solar receiver will accept a collimated or concentrated input from an optical assembly intended to intensify radiant energy from the sun, and such energy may be used to drive chemical reactions or to change the phase state of a working fluid. The optical assembly itself may consist of a trough or dish or Fresnel lens that will gather incident sunlight and concentrate it to a narrow spot that will fall upon the receiver proper. Secondary reflectors may be present in the system to improve its light gathering performance. The receiver will normally consist of a thermally insulated enclosure with a transparent window which will, receive the concentrated light input that falls upon substance to be heated. Radiant transfer is the mode for energy input into the system, and the primary consideration is to dispose the reagents in such a manner that light will fall on the totality of the reactive mass, and so that light will not be reflected back through the window. The reagents will be pulverized or otherwise atomized, and agitated by various means such as a fluidized bed or the provision of a rotary drum. Alternately, a thermal transfer medium may be used to convey thermal energy from the receiver to the substance undergoing an energy conversion. Historically solar receivers have constituted the principal input for a thermochemical energy storage system, and the solar input has usually driven the exothermic reaction directly, with the concentrated sunlight falling upon the chemical to be reacted.

Heat pumps: these draw in and compress ambient air (which is properly the energy source in this instance), adding to its thermal value by means of compression, and transferring thermal energy to the chemical reagents in the second stage. Heat pumps utilize electric motors, and either pistons and cylinders or various forms of rotary compressors. Finned heat exchangers convey thermal energy conductively to the reagents or the thermal storage medium.

Heat pumps, by transferring thermal energy from the external environment, achieve paradoxically high electrical efficiencies exceeding 100% since the electrical energy is performing thermal transport rather than direct electrical to thermal conversion.

Geothermal energy collectors: geothermal energy arises from temperature gradients occurring deep underground in tectonically active regions of the earth. Today thermal storage is rarely if ever used in conjunction with geothermal generation inasmuch as the latter is a baseline energy resource and is non-intermittent. If, however, portability of energy storage were required, the two could be conjoined, in which case some form of heat exchanger would be utilized to transfer energy from subterranean steam or supercritical water to a thermochemical reactor.

### Thermal Input Subsystems Involving Energy Conversion at the Source

Such subsystems, within the overall system we envision, generally utilize electricity—the universal currency for energy transfer, as it were—as the immediate input. They then convert that electrical input into a thermal output. For the most part, such subsystems tend to operate with very high conversion efficiencies.

Such systems are intended to emulate batteries in terms of functionality and to occupy similar market niches as well.

### Resistance Heaters Where Electrical Current is Converted Into Heat by a Resistor

These normally take the form of highly electrically resistant coils that convert electron motion into heat. Heating is primarily conductive, with convection and radiance playing some part. Bringing as much of the reagent as possible into direct contact with the coil is a major concern. Depending on the reagent or reagents employed the substance may either be physically agitated by a mechanical impeller or a rotary drum, or by a fluidized or bubbling fluidized bed.

### Inductance Heaters

In such conversion devices alternating magnetic fields induce electrical currents in electrical conductors including those comprised of magnetic metals. Inductance heaters utilize coils and magnetic metal cores to concentrate magnetic flux lines which are then made to interact with a ferrous metal enclosure containing the reagent or with a reagents themselves, provided that they are electrically conductive. Inductance heaters are most effective if the reagent or the medium of conductive beat transfer are themselves magnetic, in which case hysteretic heating occurs alongside Joule heating. Given a suitable reagent or reagents. Inductance heaters will transfer heat effectively throughout the mass of the material which then need not be agitated in order to be heated thoroughly and rapidly.

### Magnetron Transmission Devices

These are thermionic devices whose microwave frequency radiant outputs excite oscillatory molecular motions in the reagents. More specifically, a magnetron is a specialized vacuum tube used in microwave radio transmission, microwave ovens, and in industrial microwave heating systems. It consists of a thermionic emitter, which produces an electron space charge; a permanent magnet; a series of magnetic pickups; and an anode collector. The magnet causes the space charge from the emitter to swirl in a vortex, and, as the electrons pass by the concentrically arranged magnetic pole pieces and gaps, the electrical fields of the electrons interact with those of the pickup coils and surrender energy to an external electrical circuit communicating with an appropriately tuned microwave antenna.

The magnetron may be regarded as a very high frequency induction heater because it makes use of the fluctuating magnetic fields in the radio waves it transmits to excite vibratory motions in the molecules of the reagents undergoing heating. Because the magnetron transfers thermal energy via electromagnetic waves, essentially a species of radiation, only the antenna or antenna array itself must communicate with the reactor. Preferably the antenna will be of the beam forming type, and will project a high intensity beam into the substance whose temperature is to be elevated.

### Combustors

These are chambers where combustible chemicals are reacted in order to produce heat. Combustors take many forms depending upon the fuel utilized, and the chemical reagent or working fluid receiving the heat of combustion. In all cases the design objective is to provide for an extensive interface between the combustion itself and the material absorbing the heat of combustion.

In some cases combustion takes place within pipes or a labyrinth of cellular cavities whose walls communicate with the chemical reagent or working fluid which occupies its own receptacle. In other cases the material to be heated occupies channels or pipes while combustion is confined to a single chamber filled by those pipes or chambers. in both types of combustor high pressure mechanical injectors may be present to introduce the fuel in measured amounts. Such injectors may be utilized for gases, liquids, or powders. Separate injection systems may be used for fuel and air. Again, depending on the fuel, combustion atmospheres other than atmospheric air may be used such as pure oxygen or nitrogen, in the case of magnetic powdered metal fuel, electromagnets may be used introduce the fuel and sequester the oxide wastes. Two specific types of combustor are particularly well suited to use within this invention by virtue of their efficiency.

Flameless combustors achieve combustion without the formation of a flame. The fuel air mixture is preheated by recuperating the heat of prior combustion whereupon it bums thoroughly and instantaneously without flaming.

Porous combustors are generally flameless as well, and combustion takes place within cellular cavities. The porous structure is thermally conductive such that preheating occurs as a matter of course.

### Radioisotope Reactors

These are energy sources in which the radioactive decay of a nuclear fuel occurs, creating a thermal output. These are not the same as fission reactors where neutrons are splitting atoms, and where the power output can be modulated with control rods that absorb neutrons and thus regulate the rate of fission reactions occurring. Rather, radioisotope, reactors produce primarily alpha and beta radiation and lack control or accelerator devices.

Alpha rays consist of a nucleus comprised of two protons and two neutrons while beta rays consist of electrons. Alpha rays are productive of thermal energy, and thus a preponderance of alpha radiation is desirable in a radioisotope heat source.

Radioisotope heat sources typically take the form of thermally insulated enclosures made of ceramics or refractory metals with radioactive materials contained within and abutting upon a thermally conductive material. Because radioisotope reactors are themselves a form of compact thermal storage, it would be unusual though not inconceivable for them to be coupled with thermochemical storage. Such a marriage would be most likely in a mobile setting where safety concerns would preclude the presence of a radioactive material. Radioisotope reactors are necessarily closed systems, and coupling would not entail the immersion of the thermal to electric energy conversion system within the reaction chamber.

While systems and inventions of the art are designed to achieve particular goals and objectives, some of those being no less than remarkable, these inventions of the art have nevertheless include limitations which prevent uses in new ways now possible. Inventions of the art are not used and cannot be used to realize advantages and objectives of the teachings presented herefollowing.

### SUMMARY OF THE INVENTION

Comes now, Dan Sweeney and John Read with inventions of energy storage and conversion systems including devices and methods of combining thermochemical storage means with concentration cells to provide very high capacity and high energy density systems.

It is a primary function of these energy storage and conversion systems to provide highly efficient, high capacity energy systems. It is a contrast to prior art methods and devices that systems first presented here include the unique combination of a thermochemical energy storage module in thermal communication with a direct energy converter in the form of a concentration cell. In particular, a closed-loop thermochemical module receives heat input at a receiving port to drive a reversible chemical reaction.

The system achieves an ‘on-demand’ functionality because the reagents of said chemical reaction may be safely stored for long periods of time without detrimental effect. When these reagents are again reunited, they produce heat that may be transmitted to the direct energy converter arranged to convert so received heat directly into an electric output suitable for doing work on an external system. Heat from the storage system drives a working fluid of the concentration cell type direct converter to ionize it, Electrons separated from atoms or molecules of the gas at a very special membrane arranged to efficiently facilitate ion migration form an electrical current that is operable for doing work when applied to an external load. Upon recombination with the ions the working fluid is restored to its original state and becomes available for another cycle. Thus, the direct energy converter or concentration, cell is also a closed-loop system.

The invention includes integrated systems consisting of: a thermal input; a reactor where thermal energy drives a endothermic thermochemical reaction, and where the heat of reaction is efficiently stored within chemical bonds, and then ultimately released in an exothermic reaction; a heat exchanger whereby thermal energy is conveyed to a final conversion stage; and a concentration cell thermal to electric energy conversion device where thermal energy is converted directly into electricity with no other energy conversion processes taking place within this stage.

The following invention disclosure generally describes the conversion of stored thermal energy into electrical energy within an autonomous, self-contained system. Conversion takes place with high efficiency such that at least twenty-five percent of the energy introduced into the system is recovered at output. The system characteristically operates at high temperatures inasmuch as conversion efficiency is a function of the thermal gradient between the heat source and the cold sink.

The energy storage and release mechanisms occur within two discrete closed cycles and are not directly visible to any nearby observer.

The presence of an electrical output is crucial to the design and functioning of the system. Most present day energy storage technologies have for their purpose the establishment of a reserve of electrical energy since so much of our modern material civilization is based upon the use of electricity. Even when the storage medium itself makes use of kinetic or potential mechanical energy or pneumatic energy, the output, which is usually mediated by some species of energy convertor or generator, is electrical in nature.

Efficient thermal transfer from the heat source to the concentration cell is critical, and a highly unique thermal coupler is arranged to employ metamaterials, including phononic crystals, to prevent thermal leakage and achieve a near 100% heat transfer from thermochemical reactor to a concentration cell.

### OBJECTIVES OF THE INVENTION

It is a primary object of the invention, to provide energy storage and conversion systems.

It is an object of the invention to provide highly efficient small footprint high capacity energy systems arranged to receive heat as input and further to provide electricity as an on-demand output.

It is a further object to provide two stage systems thermally coupled together where first stage provides for energy storage and a second stage provides for energy conversion.

It is an object of the invention to provide a fully enclosed self contained system of high electrical output with regard to its size (high energy density).

A better understanding can be had with reference to detailed description of preferred embodiments and with reference to appended drawings. Embodiments presented are particular ways to realize the invention and are not inclusive of all ways possible. Therefore, there may exist embodiments that do not deviate from the spirit and scope of this disclosure as set forth by appended claims, but do not appear here as specific examples. It will be appreciated that a great plurality of alternative versions are possible.

### DETAILED DESCRIPTION AND PREFERRED EMBODIMENTS

Energy storage and conversion systems to provide high capacity electrical output from heat inputs are arranged as two stage systems described herefollowing with reference to specific detailed examples. The unique combination of a thermochemical energy storage module thermally coupled to a concentration cell provides a small footprint high output self contained system for energy storage and conversion.

### Thermochemical Storage—First Stage

A closed-loop thermochemical module receives heat input from any of various sources at a receiving port and this heat is used to drive a reversible chemical reaction.

Specifically, a chemical reaction that absorbs heat into a chemical bond change with respect to two discrete reagents. In a reverse reaction, the chemical working fluid returns to its initial state and releases heat. Because the recombination of reagents is readily controlled, the system operates with an excellent ‘on-demand’ feature. When electricity is desired at the system output, one need only cause reagents of the storage system to be recombined to start the exothermic reaction. Heat produced in that reaction is then passed to the second stage for direct conversion to electricity. The ‘on-demand’ functionality is further improved because the reagents of said chemical reaction may be stored for a very long time without degradation.

### Concentration Cell—Second Stage

In the system second stage, heat provided from storage is used to ionize matter and that ionized matter is mechanically divided into two constituent parts including electrons and positively charged ions. These may be separated at a very special membrane of particular construct. Particularly, the membrane is constructed to be a very thin membrane which promotes good ion migration. Electrons are separated from atoms of the gas at said membrane to form an electrical current.

The concentration cell is preferably arranged as a closed-loop system whereby after the electrical current is done doing work, electrons and ions are reunited to reconstitute the working fluid back to its original condition to be reused again at the ionization chamber.

The invention includes integrated systems consisting of: a thermal input; a reactor where thermal energy drives a endothermic thermochemical reaction, and where the heat of reaction is efficiently stored within chemical bonds, and then ultimately released in an exothermic reaction; a heat exchanger whereby thermal energy is conveyed to a final conversion stage; and a concentration cell thermal to electric energy conversion device where thermal energy is convened directly into electricity with no other energy conversion processes taking place within this stage.

These two primary components including the first stage thermochemical storage and the second stage concentration cell are coupled together via a thermal coupling or heat exchanger. The heat exchanger is arranged whereby heat that is output from the exothermic reaction of the storage system is conveyed to the concentration cell as a heat input that operates to drive the ionization reactions therein Thus, the heat exchanger lies between the system first and second stages. In some preferred versions, these two stages may be very closely coupled in space to eliminate thermic loss to the surrounding environments.

The main system components and their coupling are described in considerable detail herefollowing.

### Thermal Storage

In the context of this disclosure an energy storage system is anchored by a thermal storage medium to yield particular benefit. Thermal storage systems are at once among the most energy dense of the various subcategories of energy storage technologies, and the least expensive to construct and operate, but they have previously been characterized by poor to mediocre roundtrip conversion efficiencies compared to those of rival mass energy storage technologies. These inefficiencies sometimes arise from many different factors, but they are primarily associated with the final thermal to electric conversion stage. Such deficiencies are directly addressed in this invention as this invention suggests for the first time this unique use and arrangements of the concentration cell and its components that are particularly configured to achieve remarkable efficiency.

Thermal storage is not in wide use at present, and scarcely constitutes any product category with regard to devices suitable for mass market use. In contrast, the devices taught herein are suitable for just such uses. Most existing thermal storage systems are very large scale systems built on the spot in that place where they will be used—that is, they are essentially civil works, and, in most cases, adjuncts to solar thermal electrical generation facilities. Thermal storage systems typically absorb and retain heat for lengthy durations, and eventually dispense the stored thermal energy which may be used as process heat in an industrial setting, or within a climate control system, or as a heat source for a thermal to electric energy convertor.

### Energy Density and Storage

Thermal storage recommends itself as a more general purpose energy storage modality by virtue of its superior energy density as compared to all competing methods of energy storage including pumped hydroelectric energy storage, electrochemical batteries, capacitors, high velocity flywheels, compressed air storage, superconducting magnetic energy storage, and regenerative fuel cells. Indeed, no rival storage technology is comparable.

Thermal storage falls into three subcategories: 1) sensible heat storage, 2) phase change storage, and 3) thermochemical storage. In the present invention, we are concerned with thermochemical storage.

Sensible heat storage refers to storage media that remain in a single phase as thermal energy is absorbed and released.

Phase change or latent heat storage involves a change, of phase both as heat is, being introduced and as heat is being released. Phase changes from solid to liquid and back again, or from a liquid to a gas always involve large values of thermal energy and, moreover they occur at a constant temperature, at least until the phase change is completed. Incidentally, a single thermal storage medium can operate in both the sensible heat and the phase change modes, with sensible heat storage always occurring at a temperature below that where the phase change takes place.

Thermochemical storage involves conversion of a thermal input into beat of reaction within a reversible chemical reaction. An endothermic reaction at input results in chemical reaction products that embody thermal input in the form of chemical bonds; these remain stable so long as the reaction products remain separated. When said reaction products come back together, an exothermic reaction occurs, which releases the heat of reaction that is then available for performing work.

### Utility

Endowing thermal storage with the capability of indirectly storing electricity and mechanical power greatly increases its utility, especially if the process can be performed efficiently. Secondarily, this invention provides means of efficiently converting heat to electricity in applications other than energy storage. A compact and highly efficient direct thermal to electric convertor of improved design can exploit stored heat more effectively than systems well represented in the art.

The new family of convertors of this invention can reduce the consumption of fossil fuels and other nonrenewable or scarce energy sources across a range of applications; these include transportation: stationary power; power tools; and portable, mobile, and personal electronics. Mass energy storage, remains, however, the principal near term application for this invention.

Important actual and potential applications notwithstanding, mass energy storage remains at present at an imperfect state of development. Each of the various extant technologies for storing energy presents crucial if not crippling performance shortcomings. These include major and oftentimes prohibitive capital and operational costs that restrict their use in a great many markets and applications that could benefit greatly from cost effective and flexible storage.

In this invention thermal energy storage is provided by a thermochemical reactor and a mechanical containment system for keeping reaction products spatially separated and apart from one another after the completion of the endothermic reaction. Such devices may be described in terms of chemistry or in terms of physical design, but since the same physical architectures may be used for various chemistries, the architecture is the more inclusive organizing principle. All such devices include both reactors where the actual reactions take place and receptacles for storing the reaction products. In some cases the reaction space may do double duty by storing one reaction product subsequent to the endothermal reaction. In other cases reaction products are stored in separate containers adjacent to but apart from the reactor itself. The reactor's mode of managing the reaction determines the category that it occupies, and that mode will in turn depend upon whether the reagents are exclusively fluids or whether at least one reagent is a solid.

### Fluid-Fluid Reactors

Fluid-fluid reactors support reactions where only fluids are present. This subcategory of thermochemical reactor storage system includes column or tower type reactors and tank reactors. In some versions of the invention, fluid-fluid reactors are deployed and provided with either tower type or tank reactors. Reagents are stored in dedicated receptacles in all cases. Electrically controlled valves dispense the reagents in measured incremental amounts from the receptacles, and reaction products are readmitted to the storage containers by pumping apparatus that convey the reagents from a reaction chamber into separated volumes where they can be stored for long periods. For the output portion of the reaction chamber, the reaction chamber is thermally insulated, and it communicates with a thermal transport system to convey the beat of reaction to the system second stage, the concentration cell to which it is thermally coupled.

The thermal transport system may be conductive, convective, or radiative, or may use two or three thermal transport modes simultaneously. In the case of convective or radiative transport systems, the system itself may be passive or active, with active systems utilizing electromechanical or electronic apparatus to modify the channel over which thermal transfer takes place.

Fluid-fluid reactors take two principal forms.

Column reactors lack agitators and are largely passive. The denser fluid enters at the top, while the less dense fluid enters at the bottom so the two are in a counter-flow relationship.

Tank reactors include electrically actuated mechanical agitators such as impellers, turbines, and stirrers.

### Solid-Fluid Reactors

These support reactions where at least one solid reagent is present. Several variants exist within this subcategory.

Rotary Kiln Reactors

In some versions of the first storage stage of these systems, the reaction chamber is arranged as a rotary kiln reactor where a solid reagent is tumbled in a spinning cylinder while being exposed to a fluid reagent or simply to heat. In one version the solid reaction product would remain in the kiln, while in another alternative version the solid would be conveyed to its own receptacle. In versions where the solid is stored outside the reaction space, an Archimedes screw is preferably used to convey the solid powder between the storage space and the reaction space. A vacuum pump may be deployed to sequester fluids. A rotary kiln can necessitate the use a conductive or convective heat exchanger occupying the axis of the chamber with the chamber spinning axially around it. Alternately, the wails of the spinning chamber would pass over a thermal transport fluid, transferring heat to that fluid with considerable rapidity as the solid surface of the kiln passes through the fluid.

### Packed Bed Reactors

Packed bed reactors situate a powdered solid within a grooved or otherwise compartmentalized bed where the surface over which reactions take place is maximized, and where the powder is exposed to gaseous or liquid reagent or to a heat source. The bed itself may be tiered, and the surfaces of the bed may be provided with catalytic coatings. The powdered reaction products may be stored outside of the reaction area in some versions. A mechanical or ultrasonic agitator may be present for promoting the reaction.

A packed bed reactor may make use of a resistance heater, an inductance heater, a radiant heater or a microwave heater. The heating element will be closely coupled with the reactor, and it will protrude within the reaction cavity itself. The use of a resistance heater would be suboptimal because of the difficulty of disposing the reagent so that all of the material is in proximity to the thermally conductive surface of the resistance heater.

The packed bed reactor communicates with any of several types of thermal to electric convertor and is agnostic with respect to the convertor type. Conductive, convective, or radiant thermal transfer systems may be used, but purely conductive systems are suboptimal due to the relatively low thermal fluxes that they support and the low velocity of thermal transfer. In some cases a fluid reaction product retaining thermal energy may double as an energy transfer fluid.

If a thermal transfer fluid is utilized, it may undergo a phase change and vaporize and thereby convey thermal energy, or it may be pumped by mechanical or magneto-hydrodynamic means, or both a phase change and pumping may occur. In the case of mechanical pumping, wall jet impingement may be utilized to achieve maximum thermal transfer. A wall jet is a stream of pressurized fluid that impinges upon the surface to be heated and then follows the contours of that surface due to the Coanda effect.

Fluidized Bed Reactors

Fluidized bed reactors introduce the fluid under pressure, and induce a turbulent mixing process for the reagents. The reaction space is open and lacks the intricate matrix structures present in a packed bed reactor. Storage of solids in dedicated receptacles may be present as well as mechanical means of conveying the powder to and from the receptacles. Resistance, reluctance, and radiant heaters may be utilized, and with this type of reactor, resistance heaters become more practical because the fluidized mixing process will bring all or nearly all of the solid reagent material in contact with the thermally conductive surface of the resistance heater. The interaction of fluidized reactor with the thermal to electrical convertor is not notably different than is the case with a packed bed reactor, but the design especially lends itself to convective heat exchangers because the fluidized bed itself participates in convective thermal transfer.

Honeycomb Reactors

In honeycomb reactors the solid reagent is bound to an open celled supporting matrix and it forms a thin layer over the matrix. Fluids pass through the interstices within the honeycomb, reacting with the thin solid layer. Only the fluid is stored in a dedicated container while the consolidated powder remains on the matrix structure.

The honeycomb reactor is a simple design but presents difficulties in terms of thermal transfer. Resistance, conductive, microwave and radiant electrical heating schemes are possible, and resistance heating is especially attractive inasmuch as branched resistance heaters can be incorporated within the honeycomb itself. Thermal transfer to the thermal to electrical convertor may take place via conduction, convection, or radiation, but providing convective channels through the honeycomb matrix gives rise to problems in fluid transport.

### Hybrid Thermochemical Storage

Ordinary hydrogen gas (H2) is of proven utility as an energy carrier and energy storage medium, most frequently within the context of regenerative fuel cells. It becomes an electrical energy storage medium if it is derived from water through the process of electrolysis. The maximum efficiency of water electrolysis to date has been 96%, and there is reason to believe that even higher efficiencies are possible.

Recently developed hydride storage modules permit the indefinite storage of hydrogen gas at low pressure in mode that is efficient both in terms of mass and volume.

Such gas can be incrementally released and combusted in either a pure oxygen or air atmosphere, leaving only water as an exhaust product,. The water can either be recycled or released into the surrounding environment.

### Thermal Transfer Subsystem

This delivers the recovered heat of reaction to a transducer that converts that heat into electricity. Such systems may operate by means of conduction, convection, radiation, or a combination of modes. Almost all such thermal transfer systems contain a conductive component, and the three types of systems may be combined with one another.

### Conductive Thermal Transfer Systems

Conductive systems transmit heat passively through a thermally conductive medium which is generally a solid. They are simple in concept and in their functioning, but may exhibit elaborate repetitive structures in order to maximize the surface area in contact with the heat source and the heat sink. Such simplicity does not denote a lack of sophistication, and some conductive heat exchangers utilize exotic high thermal flux materials such as amorphous diamond. Purely or largely conductive heat exchangers are commonly used in energy storage systems that include Stirling cycle engines as the output stage, but they do not provide for the highest thermal fluxes per unit of mass.

Recently a unique type of conductive thermal transfer technology known as a thermal metamaterial has been developed which allows for the concentration and highly directional propagation of heat flux. The thermal metamaterial consists of alternating layers or strips of highly conductive material separated by thermal insulation. The thermally conductive sections assume high radius curves and serve as highly directional thermal channels.

In one iteration of the thermal transfer system or thermal coupler used in these apparatus, constructions known as phononic crystals are, deployed in order to enhance the effectiveness of the thermal shielding surrounding the heat source. Phonons are compression waves and shear waves propagating through a lattice structure. Although they may be construed as acoustical in nature and therefore soundwaves traversing a solid medium, at high frequencies they convey thermal energy as well. Phononic crystals are regular, repetitive structures that act as forbidden zones or stop bands for phonons of a given frequency and energy level, and they can completely reject conductive heat and prevent its dissipation out into the external environment. They are essentially perfect insulators over the frequency range in which they are designed to operate. They consist of alternating layers or structures of materials of varying density and thus varying velocities of propagation, and when strategically arrayed conduce to destructive and constructive interference at frequencies of interest. When constructive interference occurs, no phononic energy is transferred through the crystal.

Phononic crystals are made up a matrix material in which is embedded at regular intervals another material. The inclusions are normally identical to one another and take the form of regular geometric shapes such as pyramids, cylinders, or spheres, though other shapes are possible as well. The inclusions differ from the matrix material in density and in velocity of propagation such that impinging phononic wavefronts will interfere constructively and destructively will proceed at different rates through different materials and will be phase shifted relative to one another. Destructive interference will constitute the stopband effect, and will represent a stopband or forbidden zone at the point of interference which is the interior of the crystal itself. Constructive interference will occur outside the crystal and will represent a perfect reflection.

Phononic crystals may be part of larger constructions which include “defects”, that is, spaces where the repetitive pattern and structures are not present but rather a homogenous mass of matrix material. The energy traversing such channels may be collimated and will not exhibit the diffusive nature that normally characterizes conductive heat, thanks to the presence of the phononic crystal structure. Thermal energy may also be conserved within defects forming closed cavities.

All of these constructions are only approximately similar to metamaterials that are intended to control electromagnetic waveforms, because they only handle uni-directional steady state energy flows, whereas most metamaterials are highly resonant structures designed intercept and channel waves of specific frequencies.

### Convective Thermal Transfer Systems

Convective systems utilize fluids in motion to transfer heat. Normally such systems consist of conduits which convey the thermal medium in a closed loop between the heat source and the heat sink. Convective heat exchangers usually have large surface, areas over which the thermal transport medium passes, and often these surfaces are irregular or convoluted. The larger the surface area, the greater the thermal flux that can be achieved, but this must be balanced against viscous drag and pumping losses associated with such large surface areas, and especially with surface areas begetting turbulence in the thermal transfer fluid. These convective thermal transfer systems include the following.

### Direct Thermal Transfer Systems

These are thermal transfer systems where the thermal transfer medium passes directly over the material that is the thermal receptor and is to perform the energy conversion process. These support extremely high heat fluxes but pose significant design problems in that separating the thermal transfer fluid from the thermal receptor subsequently may prove extraordinarily difficult.

### Passive Systems

In passive convective thermal transfer systems capillary action is used to impel the thermal transfer medium; these include heat pipes and thermosiphons. Wicking action occurs both in the path from the heat source to the receptor and in the return path back to the heat source, and in both paths is supported by a metal mesh. All such systems utilize the phase change from a liquid to a vapor to convey thermal energy to the receptor site at which point the fluid condenses, releasing the latent heat. Such systems support very high heat fluxes.

### Active Systems

Such systems employ either electro-hydrodynamic impulsion systems where electromagnetic forces are used to impel an electrically conductive thermal transfer medium, or, alternately, mechanical pumps are used for the same purpose.

### Radiant Thermal Transfer Systems

Radiant systems transfer thermal energy via infrared radiation, and they require no direct contact with the receptor. Radiative transfer occurs as an epiphenomenon in both conductive and convective thermal transfer systems, but is almost never the primary transfer modality in heat exchangers. In the past pure radiative transfer has been largely confined to spacecraft where the receptor is the depths of interplanetary space, such systems being used for heat rejection.

Radiant thermal transfer can support extremely high heat fluxes with ascending temperatures, and the rate of increase is to the power of four. Heat delivery occurs literally at the speed of light, and the proposed system or systems figuring in this invention are nondispersive and capable of concentrating radiant thermal energy and delivering the entire heat flux to a single point. In addition, radiation may be shaped such that it is emitted from a small area of the reactor, obviating the need for massive applications of thermal insulation.

In this invention a new type of radiant transfer system is proposed utilizing non imaging optics, gradient refractive index lenses, bent silicon crystals, and metamaterial lenses in conjunction with thermal metamaterials.

### Non-Imaging Optic

The term non-imaging optics refers to optical assemblies Where auxiliary optical components such as secondary reflectors, lenses, or prisms are present. These components are poised above the main collecting element, which usually takes the form of a dish or trough, and they capture optical spillage from the main collecting element and direct it toward a focal point. These assemblies are capable of capturing essentially all incident light and concentrating it at a single point. The technology is well established in but a single product category, namely, automotive headlights, and there is not prior art on the use of such systems to transfer heat to thermal to electric convertors.

### Gradient Refractive Index Lenses (GRINs)

These are recently developed optical devices made up alternating layers of transparent materials, each material having a different refractive index. They allow contouring of the refractive index through the lens such that light can be transmitted in any direction including back upon itself.

### Bent Silicon Crystals

These consist of successive sheets of crystalline silicon of molecular thickness resembling graphite in structure. When they are bent, curved voids will form between the sheets providing a pathway for the lossless propagation of light along curved pathways.

### Metamaterial Lenses

Metamaterial lenses consist of repetitive nano-scale structures made up of alternating conductive and dielectric materials, and which are capable of concentrating radiant thermal energy into sub-wavelength quasi-particles known as plasmons. The dimensions of such structures are a function of the wavelength being concentrated, with larger dimensions accorded to longer wavelengths. The nano structures may consist of alternating layers of metals and dielectrics, or metal spheres embedded within a dielectric layer, or metallic posts separated by an expanse of dielectric, or gapped rings of conductive metal within a dielectric matrix.

The plasmons consist of dense matter oscillations of masses of electrons and constitute quasi-particles in the manner of photons or bosons. They are deeply subwavelength relative to propagating radiation of the same wavelength, and are highly resonant and occur at the interface of the metallic elements and the dielectric. They can endow the resulting surfaces with negative permittivity and permeability, and can possess negative refractive indices such that they are capable of bending incident radiation at acute angles. Such repetitive structures measure in the nanometers at the wavelengths of interest.

### Coupling to the Heat Source

Efficient and nearly lossless transmission of thermal energy from the output of the thermal storage stage is vitally important to a system consisting of a thermochemical storage module yoked to the concentration cell and strongly impacts overall system performance as lossy thermal transmission results in system efficiencies that would otherwise exclude these system configurations. Accordingly, use of a thermal transfer device where thermal conveyance mode is characterized as radiance is preferred, and several types or versions of such radiance based thermal transmission devices may be deployed in various embodiments of this invention.

### Flow of Radiant Energy

When radiant type thermal transfer mode is deployed as the predominant energy transfer means, it is desirable to channel emitted photonic energy from the output port or outer surface of the thermochemical reaction chamber to a collimator to form a well-behaved beam of high intensity, polarized, monochromatic electromagnetic radiation. This is accomplished by use of a combination of nano-scale metamaterial devices that are wavelength selective and perfectly reflective or transmissive at the wavelengths of interest, and by non-imaging optics, meso-scale thermal metamaterials, and bent silicon crystals. These hybrid constructions will ensure that the radiant energy from the thermal storage stage to the concentration cell is not appreciably dissipated and instead is transmitted with very high efficiency over a defined pathway so as to impinge only upon the input port of the concentration cell without significant spillage or diffusion.

### Giant Radiative Transfer

In one most preferred arrangement, the thermochemical reactor is coupled to the concentration cell via a thermal coupler characterized as a micron gap system. Micron gap systems position the radiating surface of the thermochemical reactor's output or heat source at a distance of one micron or less away from the receptor surface or input port of the concentration cell. These are positioned in a range where the bound or surface wave is maximally intense. Surface wave energy can be transferred in its entirety to the receptor, raising system efficiencies and output levels. In arrangements that support a micron gap system, spacers are positioned to maintain the correct distances in view of thermal expansion, and the surfaces facing one another will be made substantially flat to assure a uniform gap over the aperture of the thermal transfer path. Such a scheme requires that the miner array and the surface of the reactor be adjacent to one another and separated by a gap of about one micron or less.

### Thermal Arrangement

The thermal transfer system relies on arranging a conversion system in a cylindrical manner around the reactors thermal output. This thermal output is created using a heat exchanger that communicates with the energy released from the heat of reaction occurring within the reactor. Arranging the conversion system in this surrounding manner captures the radial components of thermal energy traveling to the entire systems surroundings.

### Thin Films

The thin film electrolyte is sandwiched between the anode and cathode layers of the membrane assembly.

A coarse, porous layer of molybdenum makes up the first layer of the entire membrane assembly. It serves two functions, the first being as a charge collector for the insulated anode terminal of the membrane, and the second function being a wicking structure to create a thin, liquid layer of working fluid on the anode side of the electrolyte. Creating this concentrated liquid layer offers the highest possible anode performance and efficient alkali ionization. Furthermore, this means that the anode can be fabricated much thicker than any other layer of the membrane assembly, even up to 1 mm or thicker, so long as a porous molybdenum structure is present.

A finer interfacing layer molybdenum with smaller pores is deposited onto the outside of this coarse layer to create a support structure, onto which the thin electrolyte material is deposited.

Sub-Micron Membrane

The electrolyte for alkali based concentration cells (known as AMTEC's) is typically an isomorphic form of alumina doped with mobile sodium (or other alkali) ions. To further reduce ohmic losses, this layer is deposited at sub-micron thickness.

Independent research indicates that achieving sub-micron thickness also introduces newly discovered modes of ionic mobility and further reductions of electrolyte resistance.

On top of the electrolyte is the cathode film. This porous film structure transfers electrons back to the alkali ions, thus returning the working fluid to a neutral charge. The cathode film is between 100 and 200 microns in thickness, and features a porous structure to allow for rarified gas flow. Like the anode, Molybdenum is a preferred material of choice for creating the cathode film.

Completing the membrane assemble is a molybdenum wire mesh that is wrapped around the outside of the cathode film. The wires of the mesh have lower electrical resistivity than the cathode film, and thus support, higher electrical currents. This mesh is electrically connected to an isolated cathode terminal on the membrane assembly, thus completing the arrangement for the open circuit of the concentration cell.

### Concentration Cell Convertor Subsystem

Thermal energy may be directly converted into electrical energy in a single energy conversion process that occurs in an apparatus herein described as a ‘concentration cell’. Thermal energy received via a coupling to the thermal storage portion of these systems is accepted as input to the concentration cell and that so received thermal energy drives a special working fluid contained in a mechanical relationship with an ion separating membrane which forms a portion of an electronic circuit. Ionization of the working fluid is realized when heat is brought and applied to the working fluid. Electrons produced in such process flow in an electric circuit as output of the concentration cell and this electric current operates to do work on any arbitrary external system.

The concentration cell may be characterized as a “closed loop system” in that the working fluid is reconstituted when ions and electrons are recombined in a condensing process which restores the working fluid to its original state and before being returned to the heat source for another cycle.

Accordingly, a concentration cell as described that is in thermal communication with the output of a thermal storage stage operates to directly convert heat from that storage system into an electrical current and pass that current as final system output.

Conversion of thermal energy into electrical energy in these systems is effectuated by such concentration cells which are a type of direct energy convertor,

Direct thermal to electric conversion devices convert a thermal input into an electrical output without the use of moving mechanical pans. In most technologies the molecular movement that constitutes heat directly impels electrons through a circuit. Direct conversion implies that a single energy conversion takes place in the convertor. Accordingly, a mechanical heat engine/generator would not qualify because thermal energy is first converted into pneumatic energy which is then converted into mechanical or kinetic energy which is ultimately converted into electricity via a dynamo for example.

Such direct conversions share certain commonalities. The oscillatory motions of valence or orbital electrons within the heat source are transferred to free electrons which themselves proceed through an external circuit performing useful work. Electrical rectification of some sort or another is normally involved in this process because the motion of the electrons towards and away from an atom nuclei that in itself constitutes palpable thermal energy or sensible heat, is in fact an alternating electrical current occurring at terahertz frequencies.

Many types of direct conversion devices are extant. This invention disclosure is directed to a single primary type, herein referred to as a concentration cell, though the notion of concentration cell includes a number of subtypes and variants and each of these may be substituted for another to realize a different species of the same invention genus.

Limitations in performance and efficiency in known applications of generation concentration cells do not arise from just one shortcoming in the arts, and thus design amendments first put forth here must collectively or individually address each problem with a solution. Such amendments may be preferably addressed from a view by following the path of heat flux and the resulting emissions through the device, and minimizing losses at each stage.

Energy storage apparatus of this teaching include an electric convertor characterized as a special type of concentration cell. A most preferred embodiment includes a specific type of concentration cell known as an Alkali Metal Thermal to Electric Convertor or ‘AMTEC’. The AMTEC version is a high performance subspecies version of a larger category known as concentration cells.

In an AMTEC type concentration cell, oxygen, hydrogen, or a vaporized alkali metal operates as a working fluid. The conversion system consists of an evaporator or heater for the working fluid, a high pressure chamber, an electrolyte membrane, a low pressure chamber, and a condenser.

The evaporator is arranged to combine the heat or thermal energy input with the working fluid in the high pressure chamber whereby the working fluid is vaporized. This process includes forming an ionic gas and free electrons and these are separated from each other at the electrolyte membrane. The electrons collectively form a current that passes in a conduction circuit to perform work on an external load.

In the low pressure chamber, heat is rejected and the positive ions having passed through the membrane are reunited with the electrons from the return circuit. The condenser operates on the working fluid that is then drawn back to the heat source. Concentration cells are unique direct thermal to electrical convertors. They work by imposing a pressurized, heated working fluid upon a solid electrolyte, electrically polarized membrane. Positive ions pass through the membrane while electrons pass into an external circuit where they perform work.

Concentration cells are the only direct thermal to electric conversion devices where a working fluid is present, and, in this regard, they must be considered subject to the constraints of Carnot laws. As the name ‘concentration cell’ includes the indicator ‘cell’ the implication includes the construct of a plurality of concentration cells that take the form of small repetitive structures or cells containing individual diaphragms and expansion chambers, and electrically connected in series to raise the total system operating voltage. Single cell operating potentials are usually under one volt and this value is fixed by way of the nature of the chemistry.

### Alkali Metal Type Thermal To Electric Convertors

Most concentration cell systems deployed in systems of the art have used vaporized alkali metal as a working fluid, and have taken the form of a heat pipe or thermosiphon with the separation membrane dividing the cold sink cavity into two chambers, the aforementioned high pressure Chamber and a low pressure chamber on the opposite sides of the membrane. Almost all such systems have used vaporized sodium as a working fluid. Potassium has been occasionally substituted.

The evaporator preferably is arranged in the form of a metal wick or wire mesh that thermally communicates with a heat source, in the present invention, the thermochemical reactor is the heat source that provides energy to the concentration cell by way of its efficient thermal coupling thereto. Expanding metal vapor presses against the membrane, and the positive ions condense upon it and pass through it, occupying a succession of interstitial voids or vacancies in their journey from one side of the membrane (high pressure side) to the, other side of the membrane (low pressure side). The energy conversion area generally takes the form of tubular cells with the low pressure region on the inside of the tube. A second set of metal wicks returns the condensate to the evaporator through capillary action in one preferred version.

These concentration cell direct energy converters are characterized as closed cycle systems where the working fluid is retained within the device and oscillates between two modes as input heat drives the action. In the systems of the art, membranes are comparatively very thick and typically measure a millimeter or more. In strong contrast, these apparatus include membranes that are less than a micron in thickness—many thousands or even a million times thinner. This clear distinction provides significant and unexpected performance advantage. These novel membrane configurations not found in known concentration cells of the art with respect to thickness greatly increases ionic conductivity across the membrane as well as efficiency. Concentration cells having alkali metal working fluids conform to the Rankine thermodynamic cycle where the working fluid undergoes reciprocal phase changes during heating and cooling.

To date all such devices have used beta alumina ionic membranes though other electrolyte chemistries may be possible. Vapor pressures within the system are low to permit wicking to take place and this limits the power outputs per unit of volume in such systems.

Positive ions pass through the membrane while electrons pass into an external circuit where they perform work. The output is low voltage direct current.

In this device an alkali vapor working fluid is imposed upon a solid electrolyte, electrically polarized membrane. The membrane is made of beta alumina, that is, aluminum oxide doped with sodium or some other alkali metal. The working fluid is ionized at the electrode/membrane interface.

As the name implies, concentration cells often take the form of small repetitive structures or cells containing individual diaphragms and expansion chambers, and connected in series to raise the operating voltage. Single cell operating potentials are usually under one volt. Concentration cells may adhere to a number of thermodynamic cycles depending, upon the working fluid used, but AMTECs always follow the Rankine cycle. The alkali metal working fluid will undergo phase changes in which it boils, expands, and condensed back into a liquid, and thus cells using alkali metal working fluids adhere to the same well known Rankine cycle characterizing most steam engines. Concentration cells of whatever sort benefit from the use of thin film solid electrolyte membranes. Such membranes measure in the tens or hundreds of nanometers in thickness and represent rupture hazards in the presence of pressure differentials. In order to forestall the possibility of rupture the cell itself is preferably arranged in the form of two nested cylinders on a common axis. Expansion of the gas may occur in either of two directions radially inward or radially outward, from the outer to the inner cylinder or vice versa. The curved surfaces exert membrane mechanical effects and will exhibit maximal mechanical strength as a result of such geometric construction.

### Physical Dimensions and Scalability

AMTEC type concentration cells of these inventions can be arranged in various sizes from those which may be characterized as ‘table top’ models to units with dimensions of over a meter and weights exceeding 2,000 kilograms. As these arrangements are highly modular in their construction there is little or no practical upper limit on size.

Construction with Particular Reference to Insulation

Enclosures for AMTEC type concentration cells are preferably made of highly durable stainless steel material. If certain specific designs call for sufficiently high operating temperatures, refractory metals may be required, nickel steel being the least costly option but incapable of enduring the highest operating temperatures. Supports for electrolyte membranes are preferably arranged as porous molybdenum or rhenium which tend to resist membrane delamination in the face of thermal cycling. These supports also function as the system electrodes.

Vapor pressures within the system are low to permit wicking to take place, and this limits the power outputs per unit of volume in such systems. Conceivably such systems could use mechanical or magneto-hydrodynamic pumps to return the working fluid to the heat source rather than capillary action. In AMTECs the working fluid and the thermal transfer fluid are essentially one and the same, namely, the alkali metal vapor and the AMTEC itself functions as a high temperature beat pipe as well as a thermal to electric convertor.

With respect to minimizing thermal losses and retaining heat within the system ceramic fiber is the most cost effective thermal insulation. This will require the construction of a double walled enclosure with the insulation disposed within the space between the cases. Vacuum insulation with an evacuated space between double walls may be required in critical applications. The application of photonic crystals on the inner surface of the outer enclosure wall can ensure the total reflection of radiant energy and photon reuse within the assembly.

### Rejection of Waste Heat Subsequent to Expansion of the Working Fluid

The working fluid must be cooled prior to undergoing a subsequent compression stage after which heat may be reintroduced from the heat source. Cooling may be accomplished by providing an area of thermally conductive surfaces within the cold chamber and thermally conductive surface area on the exterior of the receptacle containing the expanded working fluid.

### Oxygen or Hydrogen Based Concentration Cells

In systems where oxygen or hydrogen comprises the working fluid of the concentration cell, there is no evaporation nor condensation but merely expansion and subsequent contraction and loss of pressure in the ‘working fluid’ or gas. The process of ionization is similar to what occurs in concentration cells of the alkali metal types, but the return of the working fluid to the heat source in those cases may involve either mechanical pumping or electrostatic attraction of the working fluid. When a concentration cell is arranged with hydrogen gas as the working fluid, the spent gas undergoes absorption into a hydride which then receives an input from the heat source via a heat exchanger in order that the absorbed hydrogen can then be re-released and ionized again in a closed cycle.

Concentration cells versions of these inventions arranged to use oxygen or hydrogen as working fluids follow the closed Brayton or Ericsson thermodynamic cycles. In all cases large surface area beat exchangers are used both to efficiently convey thermal energy to the working fluid and to reject and extract waste heat from it at the conclusion of the expansion cycle. Accordingly, these concentration cell direct energy converters include such constructs in specific configurations to account for proper amounts of heat energy transfer.

Low ionic conductivity across the membrane is the biggest loss factor in previously known systems presently being practiced by experts. Thus, the present teaching stands in stark contrast to those systems and is clearly distinct because the systems taught herein include thin-film membranes, a ‘thin-film’ membrane is a membrane of thickness less than about 10 microns and greater than about 0.2 microns, which greatly improve ionic mobility. It is an unexpected result that efficiencies achievable as a result of use of such thin membranes are so much higher than those other practitioners are able to realize in any form of their systems.

Additional loss factors are quite significantly present in devices of the arts, including losses in thermal transport and ohmic losses in external electrical circuits. Conversely, the invented systems first presented herein including these thin film electrolyte membranes mitigate those losses. Oxygen and hydrogen based cycles permit considerably higher temperature gradients than is the case with the AMTEC where the working fluid condenses at the high hundreds of degrees Celsius.

One will now fully appreciate how these high performance energy storage and conversion systems may be arranged to arrive at excellent results. Although the present invention has been described in considerable detail with clear and concise language and with reference to certain preferred versions thereof including best modes anticipated by the inventors, other versions are possible. Therefore, the spirit and scope of the invention should not be limited by the description of the preferred versions contained therein, but rather by the claims appended hereto.

1) Energy storage apparatus comprising:
a thermochemical reactor; and
a concentration cell,
said thermochemical reactor is thermally coupled to said concentration cell whereby heat conveyed from said thermochemical reactor is received at said concentration cell and converted to an electrical output.

2) Energy storage apparatus of claim 1, said thermochemical reactor is arranged as a closed loop system that converts input heat into chemical bonds via an endothermic reaction and reversibly converts same chemical bonds into heat as output via an exothermic reaction.

3) Energy storage apparatus of claim 2, said thermochemical reactor is comprised of
an input port into which heat energy may be received;
a reaction chamber arranged as an enclosed volume operable for containing therein an endothermic chemical reaction;
at least two spatially removed storage volumes;
a chemical working medium; and an output port,
said input port is arranged to receive and take in heat from a heat source and convey that so received heat to said reaction chamber whereby the heat can be imposed upon said chemical working medium in a fashion to cause a chemical dissociation in an endothermic reaction,
said at least two spatially removed storage volumes are arranged to contain therein and hold apart spatially the reagents of a chemical dissociation of said working medium,

4) Apparatus of claim 3, further comprising a thermal coupling arranged to reduce heat loss whereby nearly 100% of heat is transferred from said thermochemical reactor to said concentration cell.

5) Apparatus of claim 1, said concentration cell is comprised of a membrane arranged to spatially separate electrons from ions.

6) Apparatus of claim 5, said concentration cell is further comprised of:
a heater evaporator for the working fluid,
a high pressure chamber,
an electrolyte membrane,
a low pressure chamber in which heat is rejected to the environment and in which the positive ions passing through the membrane are reunited with the electrons that have been stripped from them, and
a condenser where the working fluid is drawn back to the heat source.

7) Apparatus of claim 5, said condenser further includes wick elements arranged to draw working fluid into a conveyance means that returns same to the heater evaporator.

8) Apparatus of claim 6, said high and low pressure chambers are arranged as a system of concentric cylindrical tubes, and said membrane is fashioned as a thin cylindrical element therebetween.

9) Apparatus of claim 6, said electrolyte membrane is about 1 micron or less.

10) Apparatus of claim 8, said electrolyte membrane is about 1 micron or less.
